(19) United States
(12) Patent Application Publication
(10) Pub. No.: US 2018/0078816 A1
(43) Pub. Date: Mar. 22, 2018

(54) REHABILITATION ROBOT INTEGRATED WITH PATIENT MOBILITY AND TRANSFER

(71) Applicant: NATIONAL CHENG KUNG UNIVERSITY, TAINAN CITY (TW)

(72) Inventors: FONG-CHIN SU, TAINAN CITY (TW); CHENG-CHUN CHENG, KAOHSIUNG CITY (TW); HSIAO-FENG CHIEH, TAINAN CITY (TW); CHIEN-JU LIN, TAINAN CITY (TW)

(21) Appl. No.: 15/272,836

(22) Filed: Sep. 22, 2016

(51) Int. Cl. A63B 23/035; A63B 21/00; A63B 24/00; A63B 23/04; A61H 1/02; A61G 5/14; A61G 5/04

(52) U.S. Cl. CPC A63B 23/03575; A61H 2201/1207; A63B 21/00069; A63B 21/00178; A63B 21/00181; A63B 21/4034; A63B 21/4035; A63B 24/0087; A63B 23/0476; A61H 1/0237; A61G 5/14; A61G 5/04; A63B 2213/00; A61H 2201/0157; A63B 21/0004

(57) ABSTRACT

A rehabilitation robot integrated with patient mobility and transfer includes a moving carrier, a posture adjustment assembly, and an exercise assembly. The moving carrier includes a main frame. The posture adjustment assembly includes a chair seat and a chair seat adjustment assembly. The chair seat adjustment assembly is connected to the chair seat and the main frame and is configured to move the chair seat with respect to the main frame to a sitting posture position and a standing posture position. The exercise assembly includes a pair of pedals and a driving assembly. The driving assembly is connected to the pedals and the main frame and is configured to drive the pedals into coordinated displacement and thereby produce a desirable rehabilitation effect.

### BACKGROUND OF THE INVENTION

### 1. Technical Field

The present invention relates to a rehabilitation robot integrated with patient mobility and transfer and more particularly to one that includes a pedal exercise bike for driving the lower limbs into coordinated movement so as to produce a desired rehabilitation training.

### 2. Description of Related Art

In Taiwan, each year sees about 500 new cases of spinal cord injuries, and almost 50% of the traumatic causes of the new cases are associated with car accidents, followed by falling from a great height, bearing a heavy weight, slipping, sports injuries, knife or gunshot injuries, and so on. Those with a spinal cord injury are generally required to be bedridden for a long time or can move about only in a wheelchair. Muscle atrophy, therefore, may eventually take place in the less frequently moved body parts, causing joint contracture and hence further limitations on mobility. In view of this, bedridden patients in general are clinically advised to receive joint-mobility and cardiorespiratory training of a proper intensity on a regular basis, for muscle atrophy tends to occur without proper rehabilitation. For example, one who has been bedridden in the hospital for a while and is just discharged may feel weakness in muscles that are used for walking. Should those muscles be unable to provide the strength required, an uncomfortable sensation will be felt when walking. Spasms are also likely.

To address the problem of muscle atrophy faced by those with a physical injury or those who are just released from a bedridden condition, U.S. Pat. No. 8,567,808, titled “Modular Standing Frame”, discloses a chair module to be tied to a user's feet and then pushed by the user or another person in order for the user's feet to swing along with the chair module. However, as the glider module 14 disclosed in the '808 patent requires the user's left and right feet to move separately but not in a coordinated manner (i.e., the left and right pedals are designed to be operated, or displaced, individually), the user may overuse muscles on the left or right side of the body, resulting in an undesirable rehabilitation effect.

### BRIEF SUMMARY OF THE INVENTION

To provide a better rehabilitation effect than can the prior art, the inventor of the present invention developed a rehabilitation robot integrated with patient mobility and transfer which includes a main body, a posture adjustment assembly, and an exercise assembly. The main body includes a main frame and a plurality of wheels rotatably connected to the main frame. The posture adjustment assembly includes a chair seat and a chair seat adjustment assembly. The chair seat adjustment assembly is connected to the chair seat and the main frame and is configured to move the chair seat with respect to the main frame to a sitting posture position and a standing posture position. The exercise assembly includes a pair of pedals and a driving assembly. The driving assembly is connected to the pedals and the main frame and is configured to drive each pedal into displacement along a separate path.

Preferably, the exercise assembly further includes a plurality of pedal connecting members, and each pedal is pivotally connected to the main frame via the corresponding pedal connecting members such that each pedal forms a four-bar linkage together with the corresponding pedal connecting members and the main frame and can be displaced along a curved path.

Preferably, the driving assembly includes a pair of handlebars and a pair of linking members, wherein: each linking member has two ends corresponding respectively to one of the handlebars and one of the pedals; each handlebar includes a grip portion, a driving portion, and a pivotal portion between the grip portion and the driving portion; the pivotal portion of each handlebar is pivotally connected to the main frame; and the driving portion of each handlebar is pivotally connected to the corresponding pedal connecting member via the corresponding linking member in order to drive the corresponding pedal into displacement.

Preferably, each handlebar further includes a bevel gear, and the bevel gears are connected to the pivotal portions of the handlebars respectively. It is also preferable that the driving assembly further includes a driven bevel gear meshing with the bevel gears in order for the handlebars to move along with each other via the driven bevel gear.

Preferably, the exercise assembly further includes a second driving assembly connected to the aforesaid driving assembly, and the second driving assembly includes an auxiliary driving motor mounted on the main frame and configured to drive the aforesaid driving assembly.

Preferably, the rehabilitation robot integrated with patient mobility and transfer further includes a pair of knee rest assemblies, wherein each knee rest assembly corresponds to one of the linking members and includes a knee rest and a knee rest linkage. Each linking member is pivotally connected to the corresponding knee rest via the corresponding knee rest linkage.

Preferably, the chair seat adjustment assembly includes a chair seat supporting frame and a lifting motor, wherein: the chair seat supporting frame is provided with the chair seat; the chair seat supporting frame and the main frame jointly constitute a double-rocker mechanism; the lifting motor has a cylinder and a lifting rod which can be moved telescopically with respect to the cylinder; and the cylinder and the lifting rod are respectively and pivotally connected to the main frame and the chair seat supporting frame in order to move the chair seat with respect to the main frame to the sitting posture position and the standing posture position.

Preferably, each pedal has one end pivotally connected to the main frame, and the driving assembly includes a pair of handlebars and a pair of linking members, wherein: each pedal corresponds to one of the handlebars and one of the linking members; each handlebar includes a grip portion, a driving portion, and a pivotal portion between the grip portion and the driving portion; the pivotal portion of each handlebar is pivotally connected to the main frame; and each handlebar is pivotally connected to the opposite end of the corresponding pedal via the corresponding linking member in order to drive the corresponding pedal into displacement.

Preferably, the driving assembly further includes a linking wheel and a pair of linking bars, wherein the linking wheel is rotatably mounted on the main frame and each linking bar has two ends corresponding respectively to the linking wheel and one of the pedals. More specifically, each linking bar has one end pivotally connected to an off-center portion of the linking wheel and the other end pivotally connected to the corresponding pedal.

Preferably, the exercise assembly further includes a pair of sliding bases and a plurality of connecting members, wherein the sliding bases are slidably provided on the main frame while each pedal is pivotally connected to the corresponding sliding base via the corresponding connecting members. It is also preferable that the driving assembly includes a pair of driving motors, a pair of output gears, and a pair of output members, wherein: each driving motor is configured to drive a driving gear into rotation; the output gears are arranged side by side and are rotatably mounted on the main frame; each output gear meshes with the corresponding driving gear and has an output shaft; each output shaft has one end fixedly connected to one end of the corresponding output member; and the opposite end of each output member is pivotally connected to at least one of the connecting members such that each output member pivots with respect to the main frame when the corresponding output shaft is rotated.

The foregoing technical features provide the following advantageous effects:

1. The driving assembly can drive the pair of pedals into coordinated movement so that the user will not overuse his or her left or right foot during rehabilitation. The present invention thus produces a better rehabilitation effect than the prior art.

2. By controlling the lifting motor, the user can freely choose which posture to assume (i.e., a sitting posture or a standing posture) while doing exercise. This allows those who are unable to stand on their own to do exercise in a standing posture and to switch to a sitting posture when feeling a loss of strength during the exercise, thereby reducing the load on the muscles.

3. Each pedal, the corresponding pedal connecting members, and the main frame form a four-bar linkage which allows the pedal to displace along a curved path similar to that of walking.

4. The handlebars can be operated by a patient or a caregiver (e.g., a family member of the patient, a rehabilitation therapist, or a nurse) so that the patient's upper and lower extremities can be rehabilitated by the patient moving the handlebars to displace the pedals or by the caregiver moving the handlebars instead.

5. While those whose upper extremities are strong enough can displace the pedals by moving the handlebars with their own hands, those whose upper extremities are too weak to move the handlebars can still drive the driving assembly with the second driving assembly. Thus, the present invention is equally suitable for use by people who are in the starting stage of rehabilitation and lack physical strength.

6. The two handlebars can move along with each other either through the bevel gear meshing with the driven bevel gears or by means of the linking wheel. In either case, the present invention is structurally simple and easy to implement.

7. The present invention not only allows a user's lower extremities to move in a way similar to walking in place, with the joints moving through relatively small angles, but also allows a user's lower extremities to move cyclically as on an elliptical trainer, with the joints of the lower extremities moving through relatively large angles.

### BRIEF DESCRIPTION OF THE SEVERAL VIEWS OF THE DRAWINGS

FIG. 1 is a perspective view of the first embodiment of the present invention;

FIG. 2 shows the chair seat in the first embodiment of the present invention in a sitting posture position;

FIG. 3 shows the chair seat in the first embodiment of the present invention in a standing posture position;

FIG. 4 is a side view of the first embodiment of the present invention;

FIG. 5 is another side view of the first embodiment of the present invention;

FIG. 6 is a front view of the first embodiment of the present invention, showing in particular the connection between two driving assemblies;

FIG. 7 is another perspective view of the first embodiment of the present invention, showing in particular the connection between the main frame and the exercise assembly;

FIG. 8 is a system structure diagram of the control system in the first embodiment of the present invention;

FIG. 9 is another side view of the first embodiment of the present invention, showing the exercise assembly in operation;

FIG. 10 is a perspective view of the second embodiment of the present invention;

FIG. 11 is a side view of the second embodiment of the present invention;

FIG. 12 is a side view showing operation of the second embodiment of the present invention;

FIG. 13 is another side view showing operation of the second embodiment of the present invention;

FIG. 14 is a perspective view of the third embodiment of the present invention;

FIG. 15 is a partial perspective view of the third embodiment of the present invention, showing in particular the connection between the main frame and the exercise assembly;

FIG. 16 is a front view of FIG. 15;

FIG. 17 is a side view of FIG. 15;

FIG. 18 is another side view of FIG. 15, showing operation of the third embodiment of the present invention; and

FIG. 19 is yet another side view of FIG. 15, showing operation of the third embodiment of the present invention.

### DETAILED DESCRIPTION OF THE INVENTION

The present invention incorporates the aforementioned technical features into a rehabilitation robot integrated with patient mobility and transfer, whose major effects are demonstrated by the embodiments that follow.

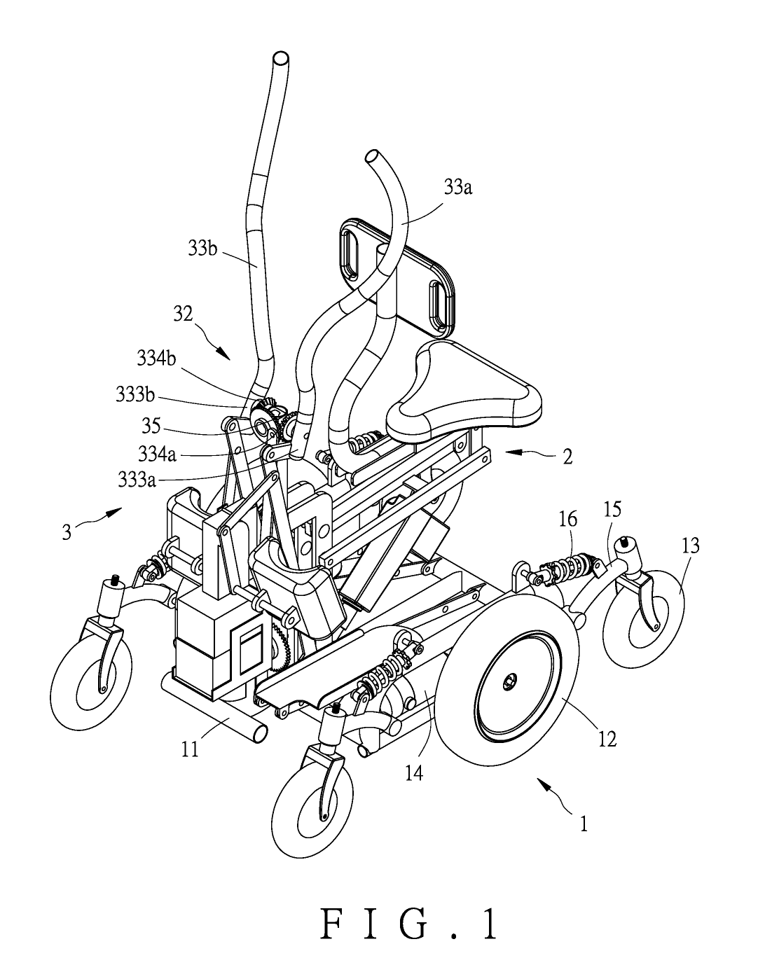

Referring to FIG. 1, the rehabilitation robot integrated with patient mobility and transfer in the first embodiment of the present invention includes a moving carrier 1, a posture adjustment assembly 2, and an exercise assembly 3.

The moving carrier 1 includes a main frame 11, at least one driving wheel 12, a plurality of auxiliary wheels 13, and at least one wheel motor 14. The driving wheel 12 and the auxiliary wheels 13 are rotatably mounted to the main frame 11. The wheel motor 14 is connected to the driving wheel 12 and is configured to rotate the driving wheel 12, thereby serving as a driving force of the moving carrier 1. The moving carrier 1, however, can be driven differently. For example, the moving carrier 1 can be displaced by being pushed by a caregiver. More specifically, the main frame 11 is pivotally connected with a plurality of auxiliary wheel mounts 15 at its front and rear sides, and each auxiliary wheel 13 is rotatably connected to the corresponding auxiliary wheel mount 15. Preferably, there is a cushioning assembly 16 between each auxiliary wheel mount 15 and the main frame 11 to reduce vibrations of the moving carrier 1 and thereby increase comfort of use.

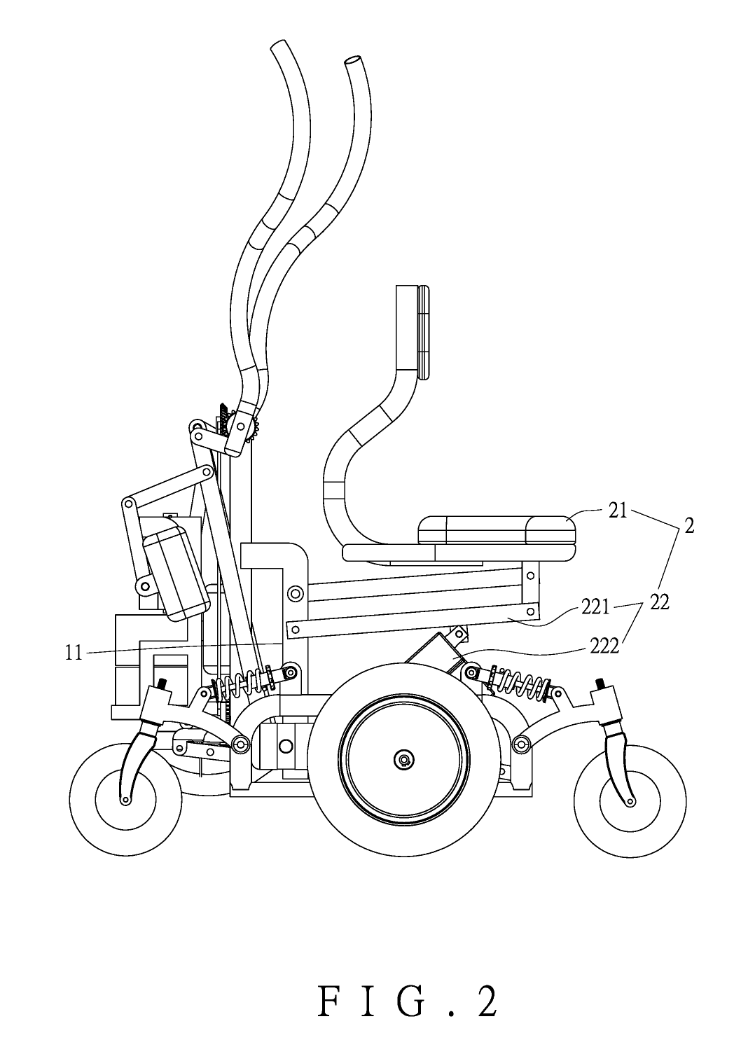

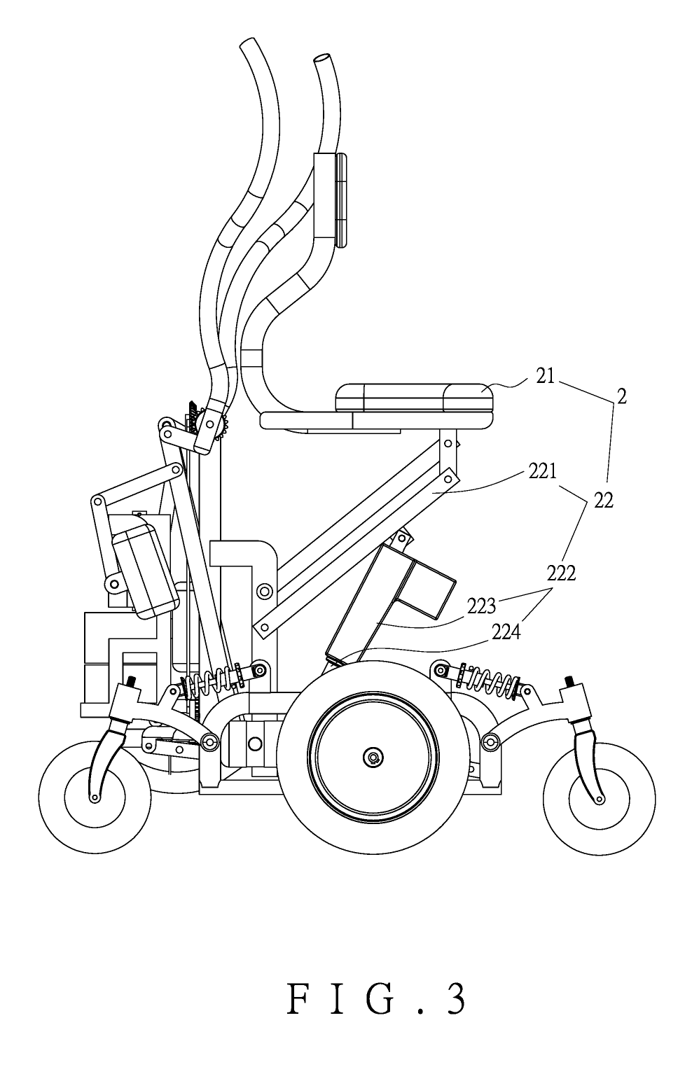

Referring to FIG. 2 and FIG. 3, the posture adjustment assembly 2 includes a chair seat 21 and a chair seat adjustment assembly 22. The chair seat adjustment assembly 22 is connected to the chair seat 21 and the main frame 11 and is configured to move the chair seat 21 with respect to the main frame 11 to a sitting posture position and a standing posture position. More specifically, the chair seat adjustment assembly 22 includes a chair seat supporting frame 221 and a lifting motor 222. The chair seat supporting frame 221 is provided with the chair seat 21. The chair seat supporting frame 221 and the main frame 11 jointly constitute a double-rocker mechanism. The lifting motor 222 has a cylinder 223 and a lifting rod 224 which can be moved telescopically with respect to the cylinder 223. The cylinder 223 and the lifting rod 224 are respectively and pivotally connected to the main frame 11 and the chair seat supporting frame 221 in order to move the chair seat 21 with respect to the main frame 11 to the sitting posture position and the standing posture position. It should be understood, however, that the chair seat adjustment assembly is not limited to the one described above, provided that it can selectively make the chair seat 21 correspond to a sitting posture and a standing posture of a human body.

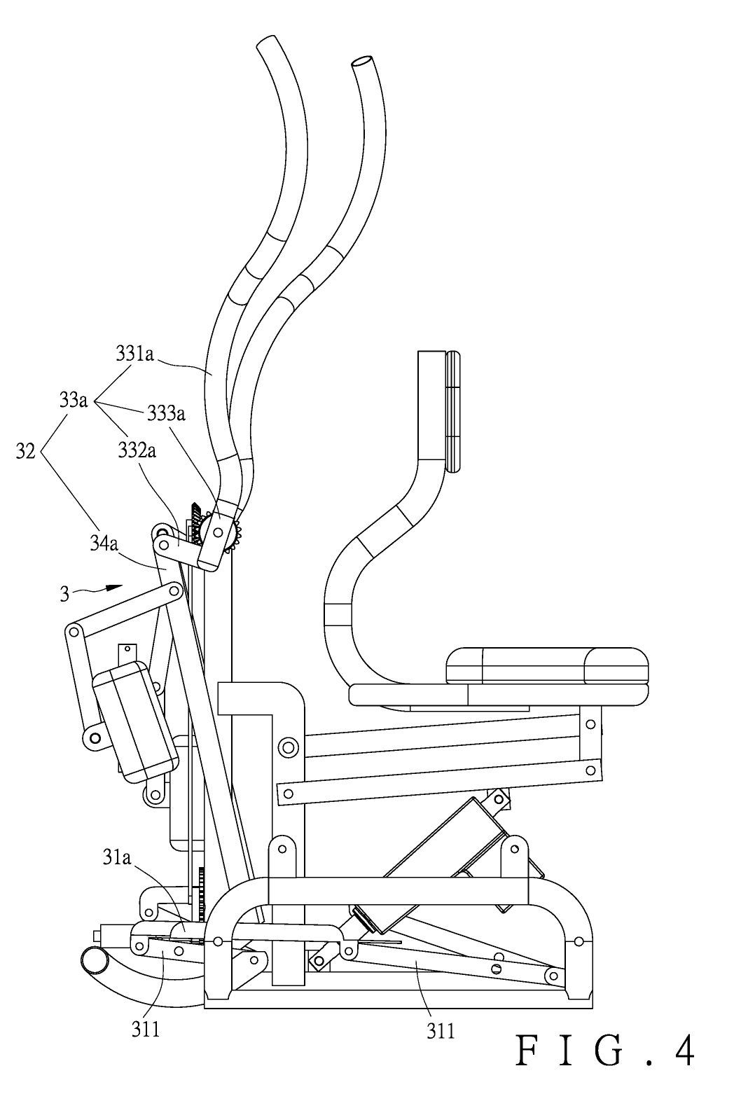

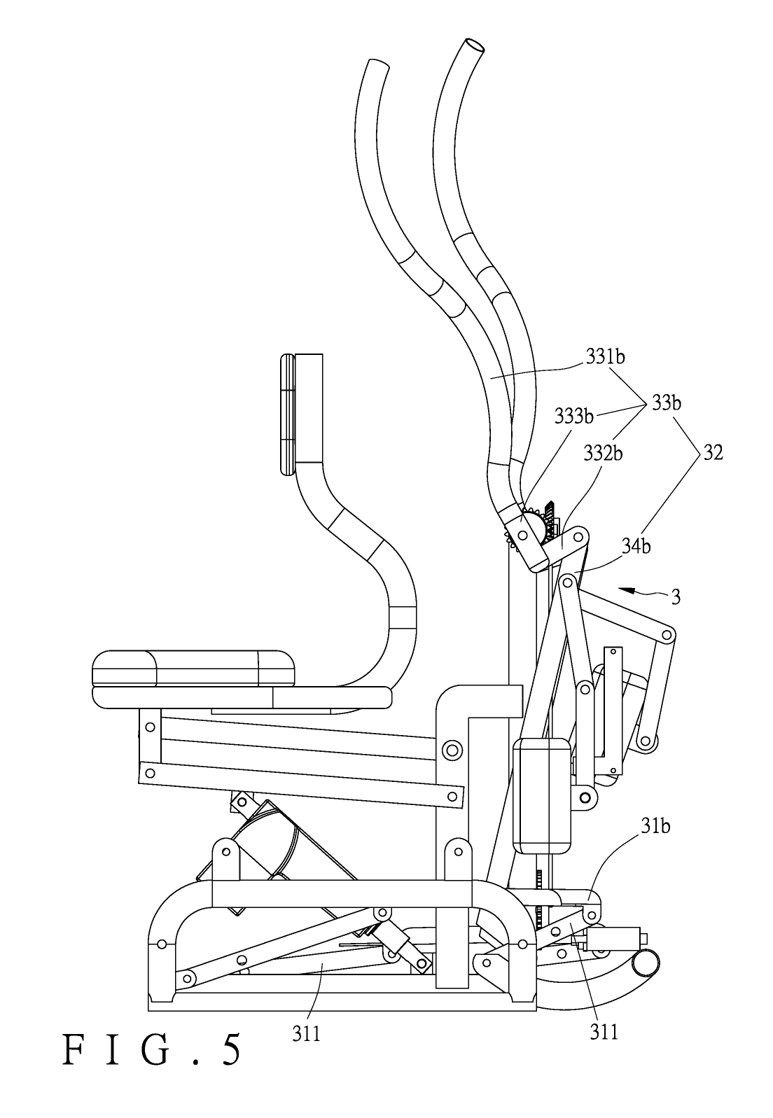

Referring to FIG. 4 and FIG. 5, which show two lateral sides of the rehabilitation robot integrated with patient mobility and transfer in the first embodiment of the present invention respectively, the exercise assembly 3 includes a pair of pedals 31a, 31b and a driving assembly 32. The driving assembly 32 is connected to the pedals 31a, 31b and the main frame 11 and is configured to displace the pedals 31a, 31b. More specifically, the exercise assembly 3 further includes a plurality of pedal connecting members 311, and each pedal 31a, 31b is pivotally connected to the main frame 11 via the corresponding pedal connecting members 311 such that each pedal 31a, 31b together with the corresponding pedal connecting members 311 and the main frame 11 forms a four-bar linkage that allows the pedal 31a, 31b to be displaced along a curved path. In practice, however, it is not necessary that each pedal 31a, 31b moves along a curved path; the pedals 31a, 31b may alternatively be moved up and down or sideways. In short, the pedals 31a, 31b must be somehow displaceable.

With continued reference to FIG. 4 and FIG. 5, the driving assembly 32 includes a pair of handlebars 33a, 33b and a pair of linking members 34a, 34b. Each linking member 34a, 34b has one end corresponding to one of the pedal connecting members 311 and the other end corresponding to one of the handlebars 33a, 33b. Each handlebar 33a, 33b includes a grip portion 331a, 331b, a driving portion 332a, 332b, and a pivotal portion 333a, 333b, wherein the pivotal portion 333a, 333b is located between the grip portion 331a, 331b and the driving portion 332a, 332b. The handlebars 33a, 33b are pivotally connected to the main frame 11 via their respective pivotal portions 333a, 333b. The driving portion 332a, 332b of each handlebar 33a, 33b is pivotally connected to the corresponding pedal connecting member 311 via the corresponding linking member 34a, 34b so as to displace the corresponding pedal 31a, 31b.

Referring back to FIG. 1, it is preferable that each handlebar 33a, 33b further includes a bevel gear 334a, 334b, which is connected to the pivotal portion 333a, 333b of the handlebar 33a, 33b; and that the driving assembly 32 further includes a driven bevel gear 35 meshing with the bevel gears 334a, 334b, in order for the handlebars 33a, 33b to move along with each other and thereby drive the pedals 31a, 33b into displacement along their respective curved paths.

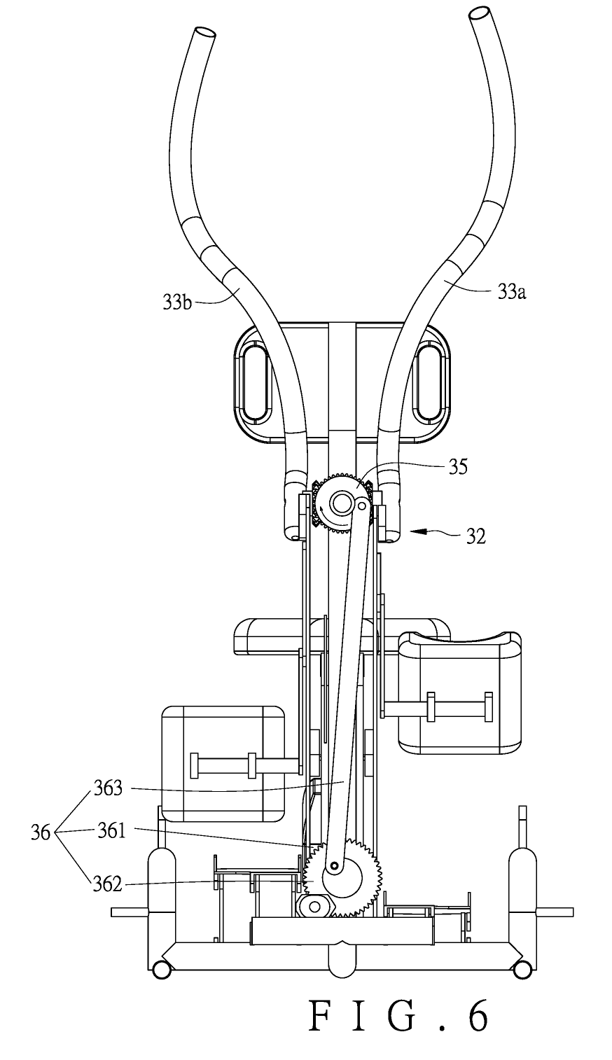

Referring to FIG. 6, it is preferable that the exercise assembly 3 further includes another driving assembly 36 (hereinafter referred to as the second driving assembly 36), which is connected to the driving assembly 32 (hereinafter also referred to as the first driving assembly 32), so that a user lacking the strength to push the handlebars 33a, 33b can still drive the first driving assembly 32 through the second driving assembly 36. More specifically, the second driving assembly 36 includes an auxiliary driving motor 361, an auxiliary driving gear 362, and an auxiliary linking member 363. The auxiliary driving motor 361 is mounted on the main frame 11 and is configured to drive the auxiliary driving gear 362. The two ends of the auxiliary linking member 363 are respectively and pivotally connected to an off-center portion of the driven bevel gear 35 and an off-center portion of the auxiliary driving gear 362. When the auxiliary driving motor 361 drives the auxiliary driving gear 362 into rotation, the auxiliary driving gear 362 rotates the driven bevel gear 35 via the auxiliary linking member 363, thereby driving the first driving assembly 32 into operation.

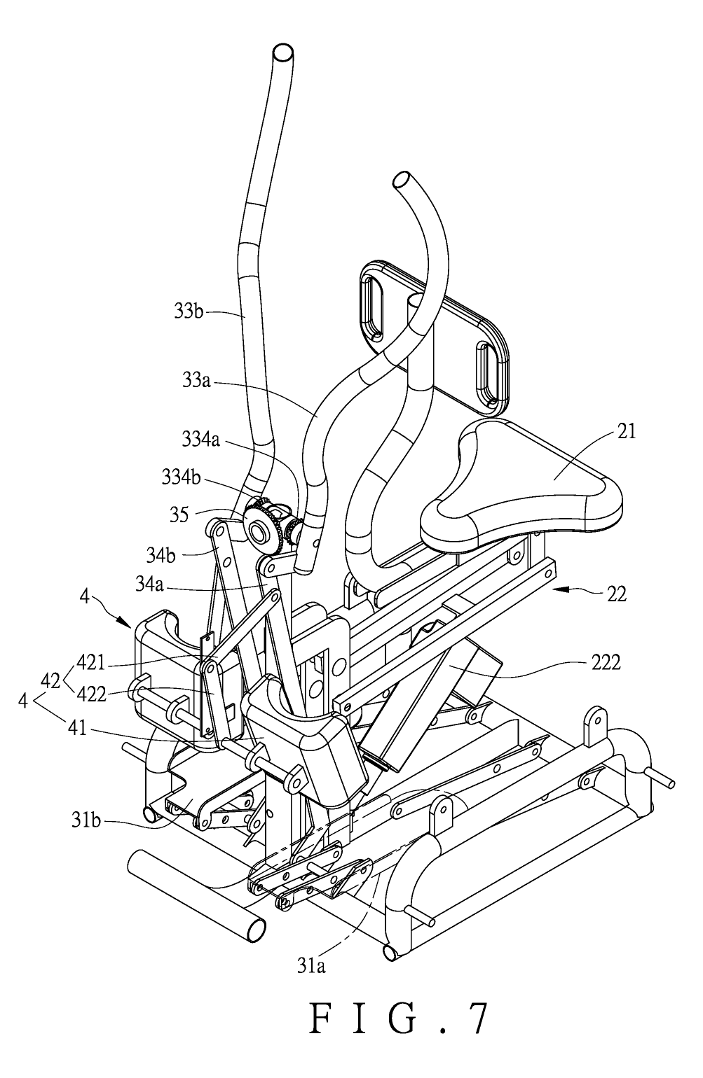

Preferably, referring to FIG. 7, the rehabilitation robot integrated with patient mobility and transfer further includes a pair of knee rest assemblies 4, each corresponding to one of the linking members 34a, 34b and each including a knee rest 41 and a knee rest linkage 42. Each linking member 34a, 34b is pivotally connected to the corresponding knee rest 41 via the corresponding knee rest linkage 42. More specifically, the knee rests 41 are so configured that a user can rest his or her lower extremities against them respectively, and each knee rest linkage 42 includes a first linking bar 421 and a second linking bar 422. Each first linking bar 421 has one end pivotally connected to the corresponding linking member 34a, 34b, and each second linking bar 422 has one end pivotally connected to the corresponding first linking bar 421 and the opposite end connected to the corresponding knee rest 41 so that the knee rests 41 can help the user move his or her lower extremities when the exercise assembly 3 is in operation.

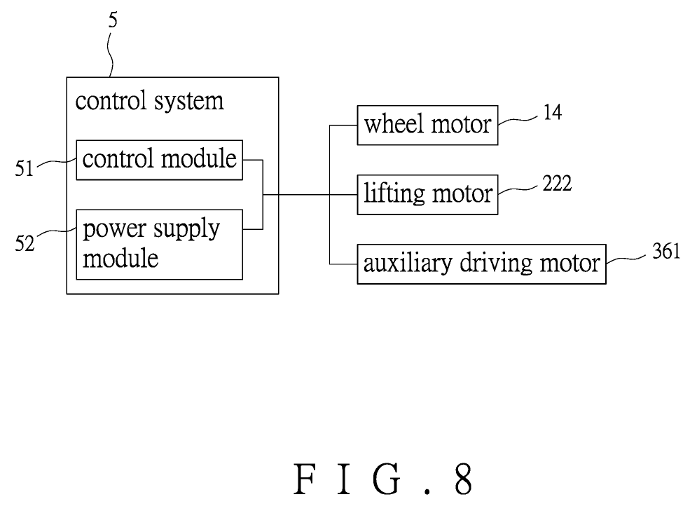

The rehabilitation robot integrated with patient mobility and transfer further includes a control system 5 as shown in FIG. 8. The control system 5 includes a control module 51 and a power supply module 52. The control module 51 and the power supply module 52 are electrically connected to the wheel motor 14, the lifting motor 222, and the auxiliary driving motor 361. The control module 51 is configured to control the ON/OFF, speeds, and switching operations of the wheel motor 14, the lifting motor 222, and the auxiliary driving motor 361 according to the user's instructions. The power supply module 52 supplies necessary electricity to the wheel motor 14, the lifting motor 222, and the auxiliary driving motor 361.

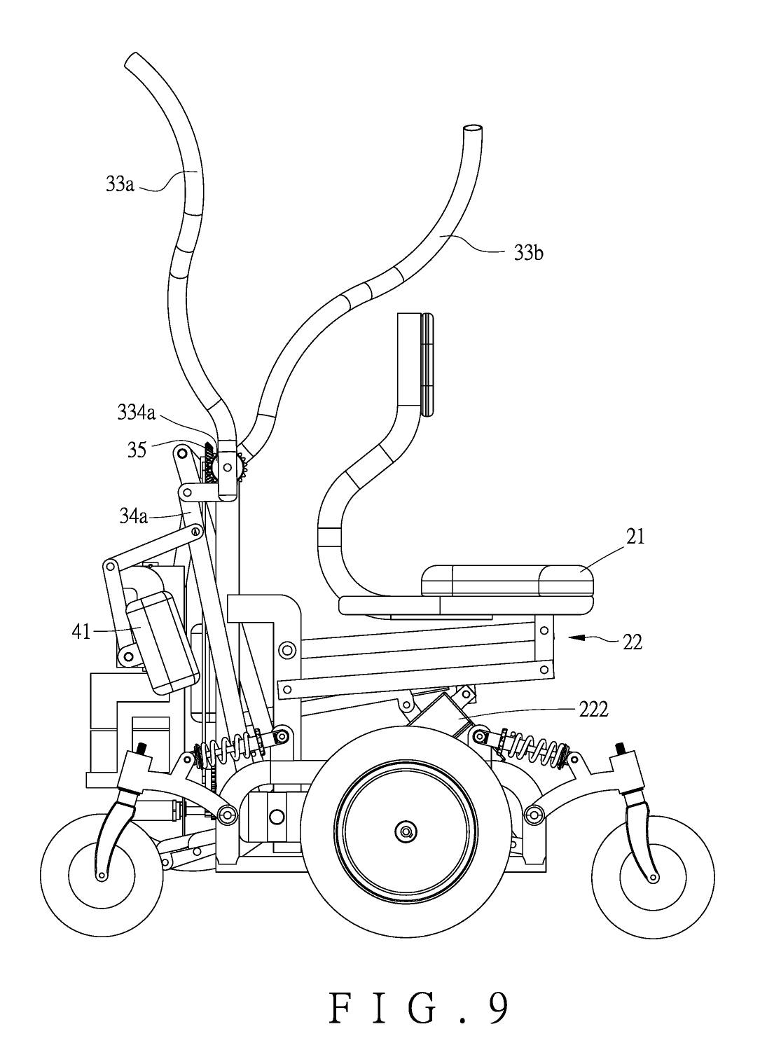

To use the rehabilitation robot integrated with patient mobility and transfer, referring to FIG. 7 and FIG. 9, the user sits on the chair seat 21 and turns on the lifting motor 222 in order to be adjusted to the desired posture (i.e., sitting or standing) via the chair seat adjustment assembly 22. Next, the user rests his or her lower extremities against the knee rests 41 respectively (the user's lower extremities may be secured by a securing means such as Velcro fasteners) to complete the preparation before exercise. After that, the user or a caregiver operates the handlebar 33a and thereby pivots the handlebar 33a. The handlebar 33a drives the pedal 31a through the linking member 34a such that the pedal 31a is displaced along a curved path. On the other hand, the bevel gear 334a of the handlebar 33a rotates the driven bevel gear 35, which in turn drives the bevel gear 334b of the other handlebar 33b. The handlebar 33b is thus pivoted and drives the other pedal 31b to displace along a curved path, thereby helping the user in rehabilitation.

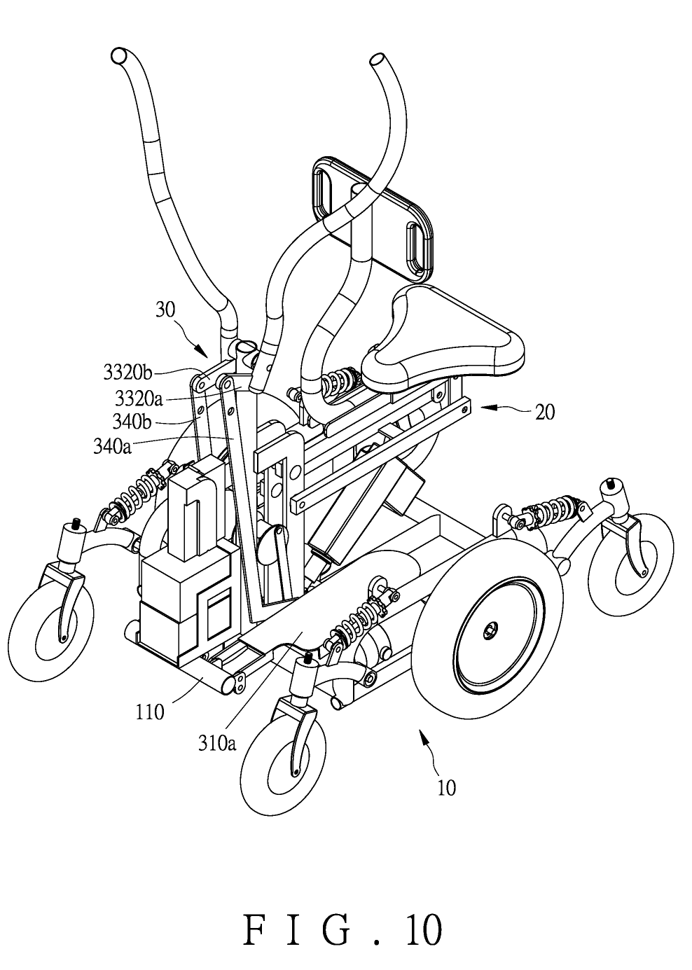

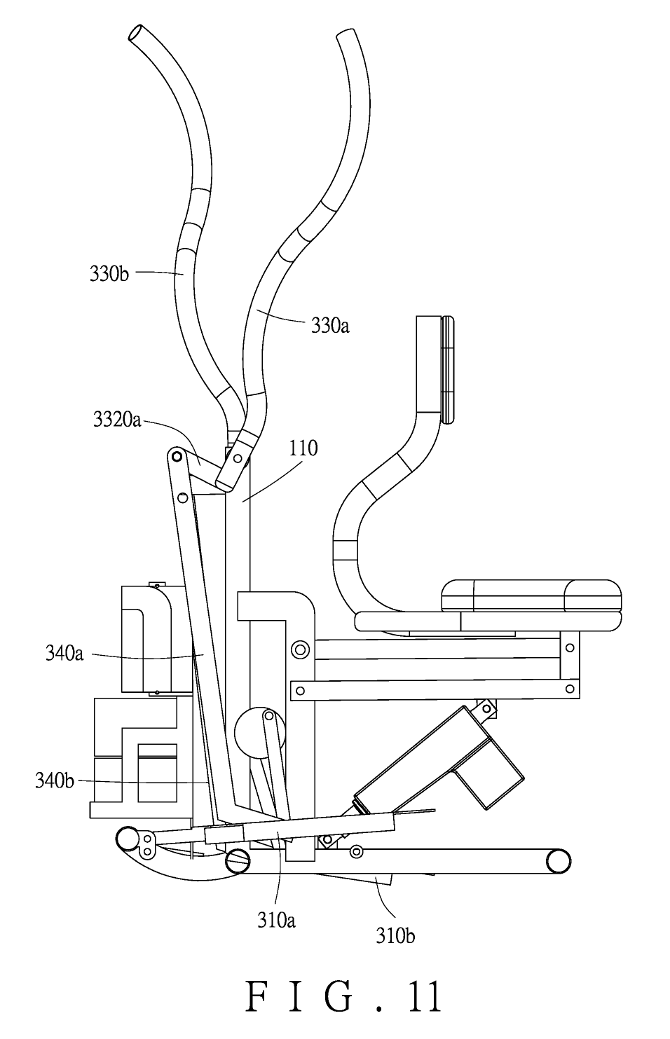

FIG. 10 and FIG. 11 show the second embodiment of the present invention, which is structurally similar to the first embodiment in that it also includes a moving carrier 10, a posture adjustment assembly 20, and an exercise assembly 30. The moving carrier 10 and the posture adjustment assembly 20 are substantially the same as those in the first embodiment. The exercise assembly 30 includes a pair of pedals 310a, 310b and a driving assembly 320.

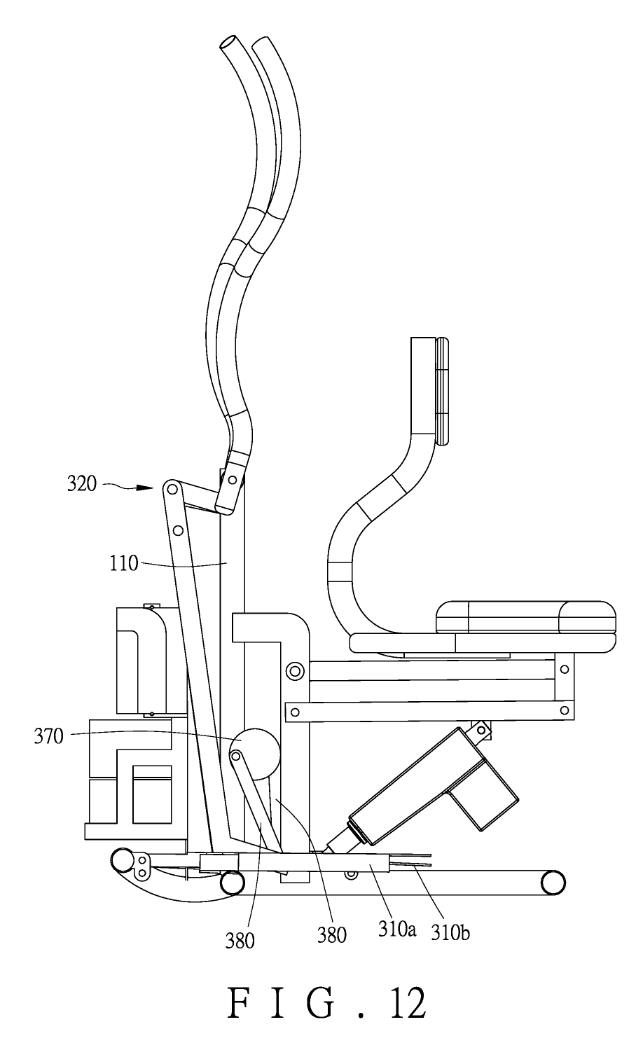

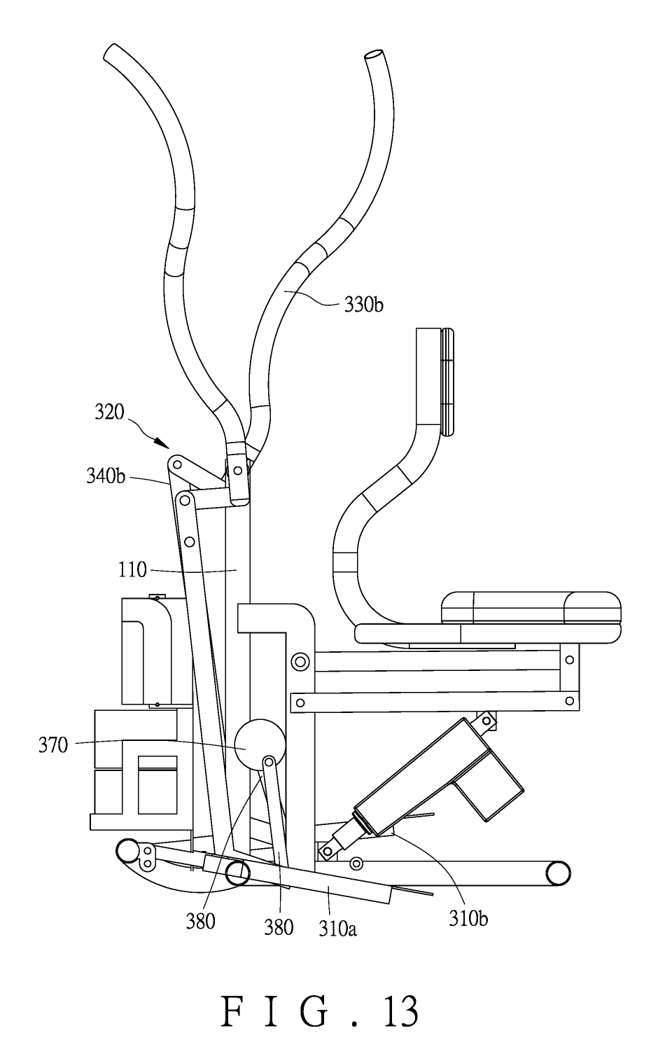

As shown in FIG. 10 and FIG. 11, the second embodiment is different from the first embodiment mainly in that the pedals 310a, 310b are not configured to form four-bar linkages. In the second embodiment, each of the pedals 310a, 310b has one end pivotally connected to the main frame 110 of the moving carrier 10. Each of the linking members 340a, 340b has two ends respectively and pivotally connected to the driving portion 3320a, 3320b of the corresponding handlebar 330a, 330b and the corresponding pedal 310a, 310b. The handlebars 330a, 330b, when operated, pivot the pedals 310a, 310b with respect to the main frame 110 via the linking members 340a, 340b respectively such that the objective of displacing the pedals 310a, 310b is equally achieved. The paths of displacement of the pedals 310a, 310b are, however, slightly different in order for the user's lower extremities to move in a way similar to walking in place (see FIG. 12 and FIG. 13), with the joints of the lower extremities moving through relatively small angles.

Preferably, referring to FIG. 12 and FIG. 13, the driving assembly 320 further includes a linking wheel 370 and a pair of linking bars 380. The linking wheel 370 is rotatably mounted on the main frame 110. Each of the linking bars 380 has one end pivotally connected to an off-center portion of the linking wheel 370 (i.e., a portion away from the rotation center of the linking wheel 370) and the opposite end pivotally connected to the corresponding pedal 310a, 310b. When one of the pedals (say, pedal 310a) is pivoted, it drives the linking wheel 370 into rotation, thereby driving the other pedal 310b into pivotal displacement. Consequently, the linking member 340b and the handlebar 330b on the other side are driven into operation.

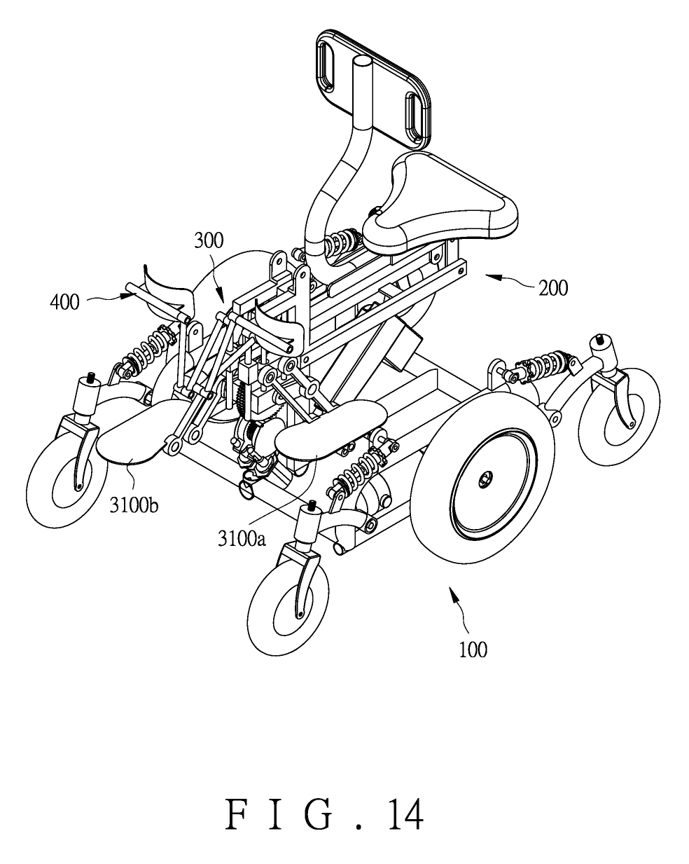

FIG. 14 shows the third embodiment of the present invention, which is structurally similar to the first embodiment in that it also includes a moving carrier 100, a posture adjustment assembly 200, and an exercise assembly 300. The moving carrier 100 and the posture adjustment assembly 200 are substantially the same as those in the first embodiment. The exercise assembly 300 includes a pair of pedals 3100a, 3100b and a driving assembly 3200. The third embodiment is different from the first embodiment mainly in that the driving assembly 3200 is devoid of any handlebar or linking member that is to be driven manually. Rather, the driving assembly 3200 only has components configured for exercising the user's lower extremities, and a pair of knee rests 400 similar to those in the first embodiment are also included.

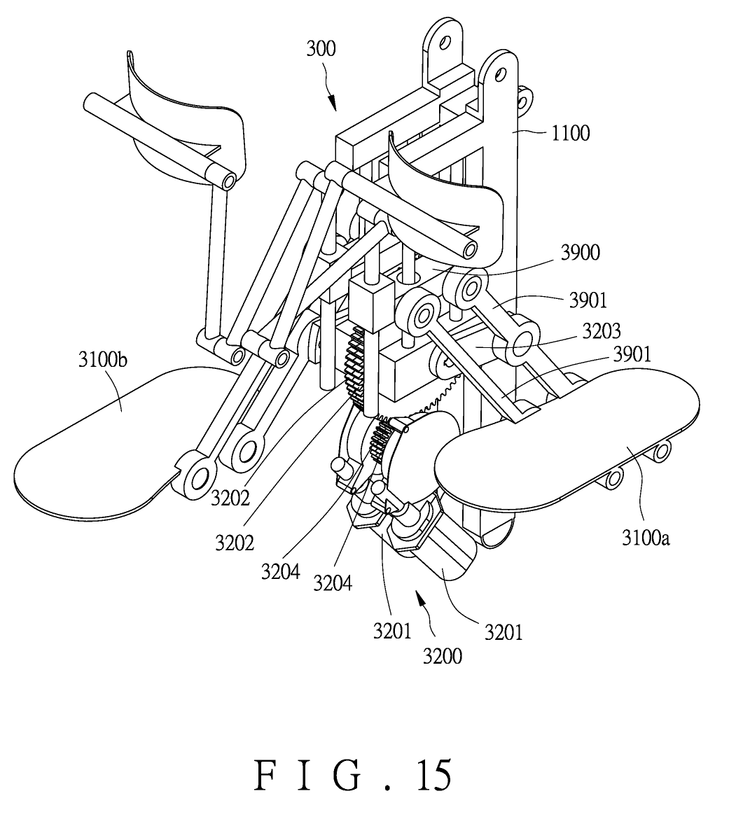

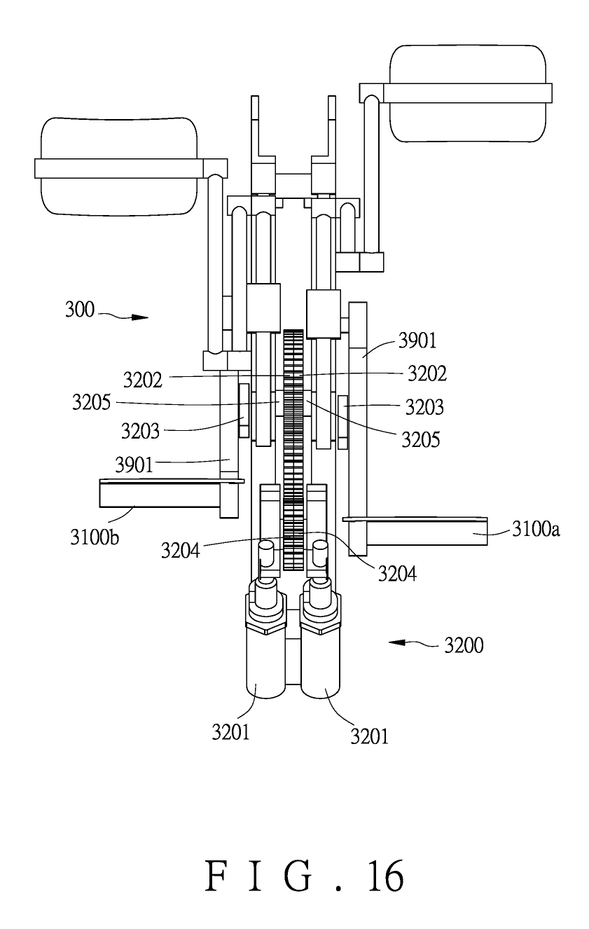

As shown in FIG. 15 and FIG. 16, the third embodiment is different from the first embodiment mainly in the following: the exercise assembly 300 further includes a pair of sliding bases 3900 and a plurality of connecting members 3901, and the driving assembly 3200 includes a pair of driving motors 3201, a pair of output gears 3202, and a pair of output members 3203. The sliding bases 3900 are slidably provided on the main frame 1100. Each of the connecting members 3901 is pivotally connected to the corresponding sliding base 3900 and the corresponding pedal 3100a, 3100b. The driving motors 3201 are configured to rotate driving gears 3204 respectively. The output gears 3202 are arranged side by side and are rotatably mounted on the main frame 1100. In addition, the output gears 3202 mesh with the driving gears 3204 respectively, and each output gear 3202 has an output shaft 3205, which is fixedly connected to the corresponding output member 3203 at one end in order for the corresponding output member 3203 to pivot with respect to the main frame 1100 when the output shaft 3205 is rotated. The opposite end of each output member 3203 is pivotally connected to at least one of the connecting members 3901.

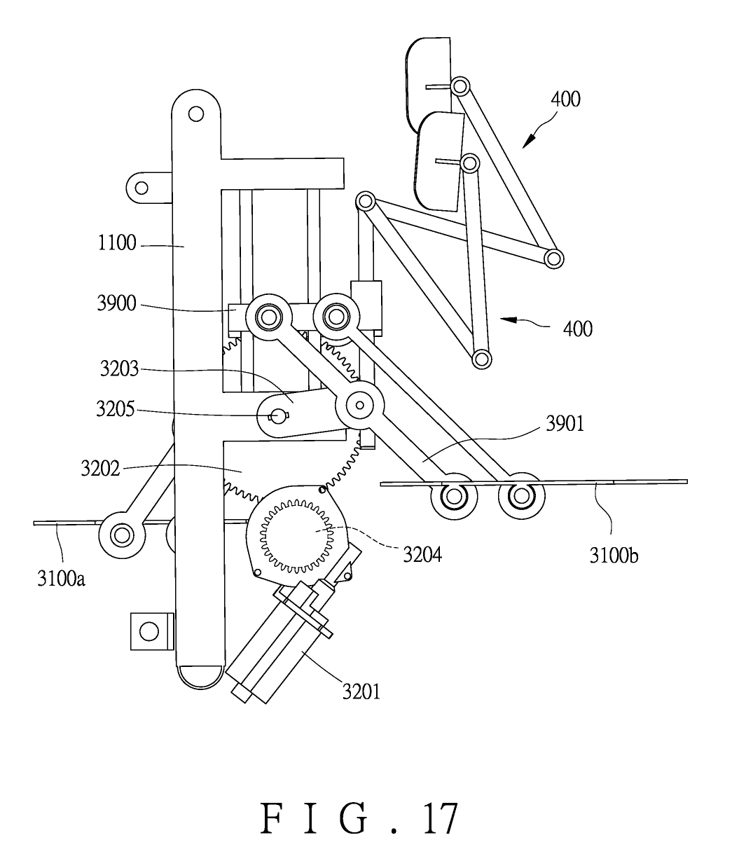

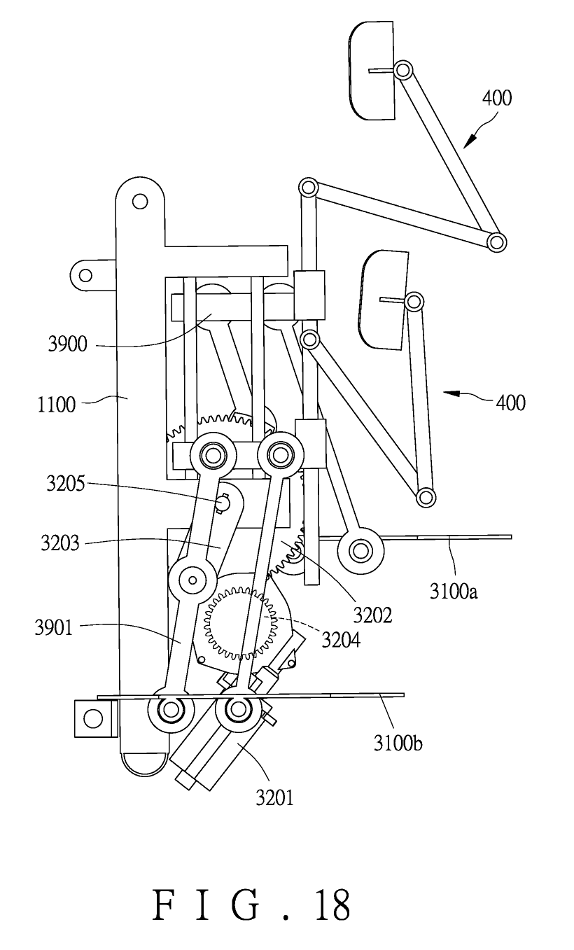

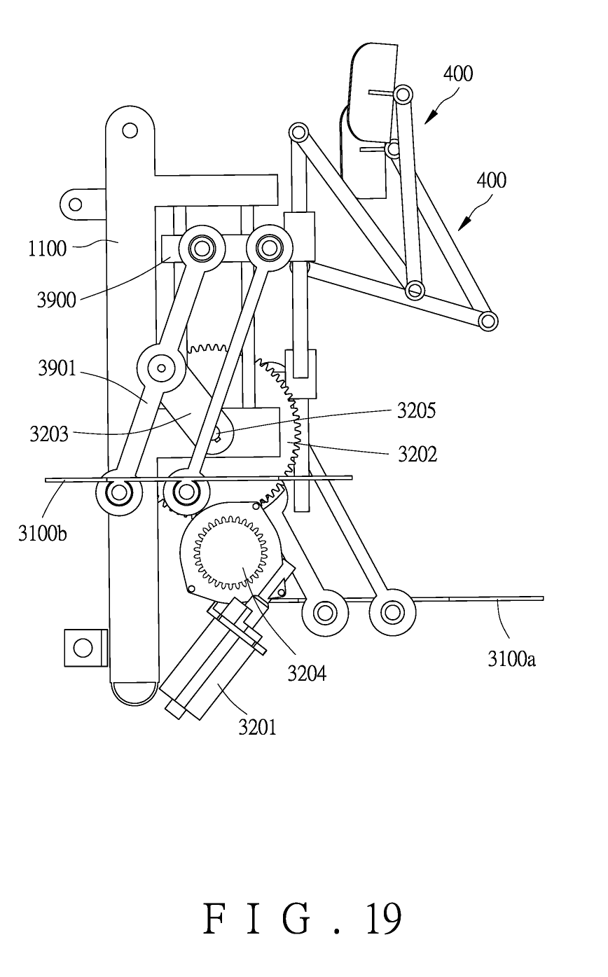

Referring to FIG. 17, when the driving motors 3201 are turned on, they drive the driving gears 3204 into rotation respectively. Then, referring to FIG. 18 and FIG. 19, the driving gears 3204 drive the output gears 3202, which in turn pivot the output members 3203 via the output shafts 3205 respectively. As a result, the pedals 3100a, 3100b are respectively driven by the output members 3203 through the connecting members 3901 to produce a cyclic movement similar to that provided by an elliptical trainer, allowing the joints of user's lower extremities to move through relatively large angles. On the other hand, the connecting members 3901 drive the sliding bases 3900 into displacement, and each sliding base 3900 drives the corresponding knee rest 400 to help move the corresponding one of the user's lower extremities.

It should be understood that the embodiments described above are only some preferred ones of the present invention and are not intended to be restrictive of the scope of the invention. All simple, equivalent changes and modifications made according to the appended claims and the disclosure of this specification should fall within the scope of the present invention.

What is claimed is:

1. A rehabilitation robot integrated with patient mobility and transfer, comprising:
a moving carrier comprising a main frame;
a posture adjustment assembly comprising a chair seat and a chair seat adjustment assembly, wherein the chair seat adjustment assembly is connected to the chair seat and the main frame and is configured to move the chair seat with respect to the main frame to a sitting posture position and a standing posture position; and
an exercise assembly comprising a pair of pedals and a driving assembly, wherein the driving assembly is connected to the pedals and the main frame and is configured to drive the pedals into displacement.

2. The rehabilitation robot integrated with patient mobility and transfer of claim 1, wherein the exercise assembly further comprises a plurality of pedal connecting members, and each said pedal is pivotally connected to the main frame via corresponding ones of the pedal connecting members such that each said pedal forms a four-bar linkage together with the corresponding ones of the pedal connecting members and the main frame and is displaceable along a curved path.

3. The rehabilitation robot integrated with patient mobility and transfer of claim 2, wherein the driving assembly comprises a pair of handlebars and a pair of linking members; each said linking member has two ends corresponding respectively to one of the handlebars and one of the pedals; each said handlebar comprises a grip portion, a driving portion, and a pivotal portion between the grip portion and the driving portion; the pivotal portion of each said handlebar is pivotally connected to the main frame; and the driving portion of each said handlebar is pivotally connected to a corresponding one of the pedal connecting members via a corresponding one of the linking members in order to drive a corresponding one of the pedals into displacement.

4. The rehabilitation robot integrated with patient mobility and transfer of claim 3, wherein each said handlebar further comprises a bevel gear, the bevel gears are connected to the pivotal portions of the handlebars respectively, and the driving assembly further comprises a driven bevel gear meshing with the bevel gears in order for the handlebars to move along with each other via the driven bevel gear.

5. The rehabilitation robot integrated with patient mobility and transfer of claim 1, wherein the exercise assembly further comprises a second driving assembly connected to the driving assembly, and the second driving assembly comprises an auxiliary driving motor mounted on the main frame and configured to drive the driving assembly.

6. The rehabilitation robot integrated with patient mobility and transfer of claim 3, further comprising a pair of knee rest assemblies, wherein each said knee rest assembly corresponds to one of the linking members and comprises a knee rest and a knee rest linkage, and each said linking member is pivotally connected to a corresponding one of the knee rests via a corresponding one of the knee rest linkages.

7. The rehabilitation robot integrated with patient mobility and transfer of claim 1, wherein the chair seat adjustment assembly comprises a chair seat supporting frame and a lifting motor, the chair seat supporting frame is provided with the chair seat, the chair seat supporting frame and the main frame jointly constitute a double-rocker mechanism, the lifting motor has a cylinder and a lifting rod telescopically movable with respect to the cylinder, and the cylinder and the lifting rod are respectively and pivotally connected to the main frame and the chair seat supporting frame in order to move the chair seat with respect to the main frame to the sitting posture position and the standing posture position.

8. The rehabilitation robot integrated with patient mobility and transfer of claim 1, wherein each said pedal has one end pivotally connected to the main frame; the driving assembly comprises a pair of handlebars and a pair of linking members; each said pedal corresponds to one of the handlebars and one of the linking members; each said handlebar comprises a grip portion, a driving portion, and a pivotal portion between the grip portion and the driving portion; the pivotal portion of each said handlebar is pivotally connected to the main frame; and each said handlebar is pivotally connected to an opposite end of the corresponding one of the pedals via the corresponding one of the linking members in order to drive the corresponding one of the pedals into displacement.

9. The rehabilitation robot integrated with patient mobility and transfer of claim 8, wherein the driving assembly further comprises a linking wheel and a pair of linking bars, the linking wheel is rotatably mounted on the main frame, each said linking bar has two ends corresponding respectively to the linking wheel and one of the pedals, and each said linking bar has one said end pivotally connected to an off-center portion of the linking wheel and the other end pivotally connected to the corresponding one of the pedals.

10. The rehabilitation robot integrated with patient mobility and transfer of claim 1, wherein the exercise assembly further comprises a pair of sliding bases and a plurality of connecting members; the sliding bases are slidably provided on the main frame; each said pedal is pivotally connected to a corresponding one of the sliding bases via corresponding ones of the connecting members; the driving assembly comprises a pair of driving motors, a pair of output gears, and a pair of output members; each said driving motor is configured to drive a driving gear into rotation; the output gears are arranged side by side and are rotatably mounted on the main frame; each said output gear meshes with a corresponding one of the driving gears and has an output shaft; each said output shaft has one end fixedly connected to one end of a corresponding one of the output members; and an opposite end of each said output member is pivotally connected to at least one of the connecting members such that each said output member pivots with respect to the main frame when the corresponding one of the output shafts is rotated.
